(19) United States
(12) Patent Application Publication
(10) Pub. No.: US 2021/0232090 A1
(43) Pub. Date: Jul. 29, 2021

(54) Image Reproduction Method and Image Analysis Apparatus

(71) Applicant: Shimadzu Corporation, Kyoto (JP)

(72) Inventors: Yusuke TAGAWA, Kyoto (JP); Ryo TAKEDA, Kyoto (JP)

(21) Appl. No.: 17/156,591

(22) Filed: Jan. 24, 2021

(30) Foreign Application Priority Data
Jan. 27, 2020 (JP) 2020-010846

(51) Int. Cl. G03H 1/00; G06T 7/50; G03H 1/04

(52) U.S. Cl. CPC G03H 1/0005; G06T 7/50; G03H 1/0443; G06T 2207/10056; G03H 2210/55; G06T 2207/30024; G03H 2001/0033; G03H 2001/005; G06T 2207/20081

(57) ABSTRACT

The accuracy of estimation of a focal distance in digital holography is enhanced. In an image reproduction method, a two-dimensional power spectrum is generated from an interference fringe image generated from object light and reference light, the two-dimensional power spectrum having an intensity specified by a first frequency in a first direction and a second frequency in a second direction. A one-dimensional power spectrum is generated by, for each frequency component specified by the first frequency and the second frequency in the two-dimensional power spectrum, associating the frequency component with a feature quantity, the feature quantity being calculated by aggregating a plurality of intensities corresponding to the frequency component. A focal distance between an object and a detector is estimated using a trained distance estimation model, the trained distance estimation model receiving, as input, a plurality of feature quantities included in the one-dimensional power spectrum.

### BACKGROUND OF THE INVENTION

### Field of the Invention

The present disclosure relates to an image reproduction method using digital holography and an image analysis apparatus.

### Description of the Background Art

An image reproduction method using digital holography has been conventionally known. For example, Japanese Patent Laying-Open No. 2018-139532 discloses a cell observation apparatus that observes a cell using a phase image generated based on a hologram taken by a digital holographic microscope. In the digital holography, a reproduced image of an object is obtained by a prescribed computation process (e.g., light wave propagation calculation), based on interference fringes formed at a detector by object light and reference light, the object light being obtained by light from a light source being diffracted at the object, the reference light directly reaching the detector from the light source. In the light wave propagation calculation, a distance (focal distance) between the object and the detector is required.

Recently, it has been known in various fields to utilize a trained model constructed by machine learning using a large amount of data, to thereby enhance the accuracy of estimation as compared with a conventional rule-based method. For example, “Convolutional neural network-based regression for depth prediction in digital holography” (T. Shimobaba, T. Kakue, T. Ito, arXiv:1802.00664, 2018) discloses a configuration for regressively estimating a focal distance in digital holography using a convolutional neural network (CNN) that receives, as input, a two-dimensional power spectrum image obtained by Fourier transform of a hologram.

### SUMMARY OF THE INVENTION

For example, when a ratio of a region occupied by an object to be observed is small in a region where an interference fringe image is taken, or when an unintended element (e.g., a scratch of a cell culture plate) is included in the region where the interference fringe image is taken, information that does not result from the object to be observed may be dominant in a two-dimensional power spectrum image. In such a case, a ratio of information related to a focal distance included in the two-dimensional power spectrum image is reduced. As a result, estimation of the focal distance may become difficult, depending on a CNN that receives the entire two-dimensional power spectrum as an input value.

The present disclosure has been made to solve the above-described problem, and an object of the present disclosure is to enhance the accuracy of estimation of a focal distance in digital holography.

An image reproduction method according to a first aspect of the present disclosure reproduces an in-focus image of an object from an interference fringe image, the interference fringe image being generated from object light and reference light, of light emitted from a light source unit to the object, the object light being diffracted at the object and reaching a detector, the reference light reaching the detector without going through the object. The image reproduction method includes: generating a two-dimensional power spectrum; generating a one-dimensional power spectrum; and estimating. In the generating a two-dimensional power spectrum, the two-dimensional power spectrum is generated from the interference fringe image, the two-dimensional power spectrum having an intensity specified by a first frequency in a first direction in the interference fringe image and a second frequency in a second direction in the interference fringe image. In the generating a one-dimensional power spectrum, for each frequency component specified by the first frequency and the second frequency in the two-dimensional power spectrum, the frequency component is associated with a feature quantity, the feature quantity being calculated by aggregating a plurality of intensities corresponding to the frequency component. In the estimating, a focal distance between the object and the detector is estimated using a trained distance estimation model, the trained distance estimation model receiving, as input, a plurality of feature quantities included in the one-dimensional power spectrum.

An image analysis apparatus according to a second aspect of the present disclosure reproduces an in-focus image of an object from an interference fringe image, the interference fringe image being generated from object light and reference light, of light emitted from a light source unit to the object, the object light being diffracted at the object and reaching a detector, the reference light reaching the detector without going through the object. The image analysis apparatus includes: a storage unit; a learning unit; and an inference unit. The storage unit stores a distance estimation model. The learning unit constructs a trained model of the distance estimation model by supervised learning. The inference unit estimates a focal distance between the object and the detector using the distance estimation model. The inference unit generates a two-dimensional power spectrum from the interference fringe image, the two-dimensional power spectrum having an intensity specified by a first frequency in a first direction in the interference fringe image and a second frequency in a second direction in the interference fringe image. The inference unit generates a one-dimensional power spectrum by, for each frequency component specified by the first frequency and the second frequency in the two-dimensional power spectrum, associating the frequency component with a feature quantity, the feature quantity being calculated by aggregating a plurality of intensities corresponding to the frequency component. The inference unit estimates the focal distance by inputting a plurality of feature quantities included in the one-dimensional power spectrum to the distance estimation model.

An image analysis apparatus according to a third aspect of the present disclosure reproduces an in-focus image of an object from an interference fringe image, the interference fringe image being generated from object light and reference light, of light emitted from a light source unit to the object, the object light being diffracted at the object and reaching a detector, the reference light reaching the detector without going through the object. The image analysis apparatus includes: a storage unit; and an inference unit. The storage unit stores a trained distance estimation model. The inference unit estimates a focal distance between the object and the detector using the distance estimation model. The inference unit generates a two-dimensional power spectrum from the interference fringe image, the two-dimensional power spectrum having an intensity specified by a first frequency in a first direction in the interference fringe image and a second frequency in a second direction in the interference fringe image. The inference unit generates a one-dimensional power spectrum by, for each frequency component specified by the first frequency and the second frequency in the two-dimensional power spectrum, associating the frequency component with a feature quantity, the feature quantity being calculated by aggregating a plurality of intensities corresponding to the frequency component. The inference unit estimates the focal distance by inputting a plurality of feature quantities included in the one-dimensional power spectrum to the distance estimation model.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing an appearance of a cell analysis apparatus, which is one example of an image analysis apparatus according to an embodiment.

FIG. 2 shows a state in which a user is arranging a cell culture plate at a prescribed location of a digital holography apparatus in FIG. 1.

FIG. 3 is a block diagram showing a functional configuration of the cell analysis apparatus in FIG. 1.

FIG. 4 shows one example of an interference fringe image.

FIG. 5 shows a reproduced image of the interference fringe image in FIG. 4.

FIG. 6 shows one example of an interference fringe image of a plurality of cells.

FIG. 7 schematically shows a two-dimensional power spectrum image obtained by Fourier transform of the interference fringe image in FIG. 6.

FIG. 8 shows one example of a histogram of a plurality of intensities corresponding to a frequency component.

FIG. 9 shows a correspondence relationship among a radius, a focal distance and a feature quantity in a one-dimensional power spectrum, and a correspondence relationship between a radius and a feature quantity.

FIG. 10 shows a network structure when a distance estimation model in FIG. 3 is a regression model.

FIG. 11 shows a network structure when the distance estimation model in FIG. 3 is a classification model.

FIG. 12 is a flowchart showing an image reproduction process performed by a processor that functions as an analysis unit.

FIG. 13 is a flowchart showing a specific process flow of a process in S12 in FIG. 12.

FIG. 14 is a flowchart showing a flow of a machine learning process performed by a processor that functions as a learning unit.

FIG. 15 is a block diagram showing a functional configuration of a cell analysis apparatus, which is one example of an image analysis apparatus according to a modification of the embodiment.

### DESCRIPTION OF THE PREFERRED EMBODIMENTS

An embodiment will be described in detail hereinafter with reference to the drawings, in which the same or corresponding portions are denoted by the same reference characters and description thereof will not be repeated in principle.

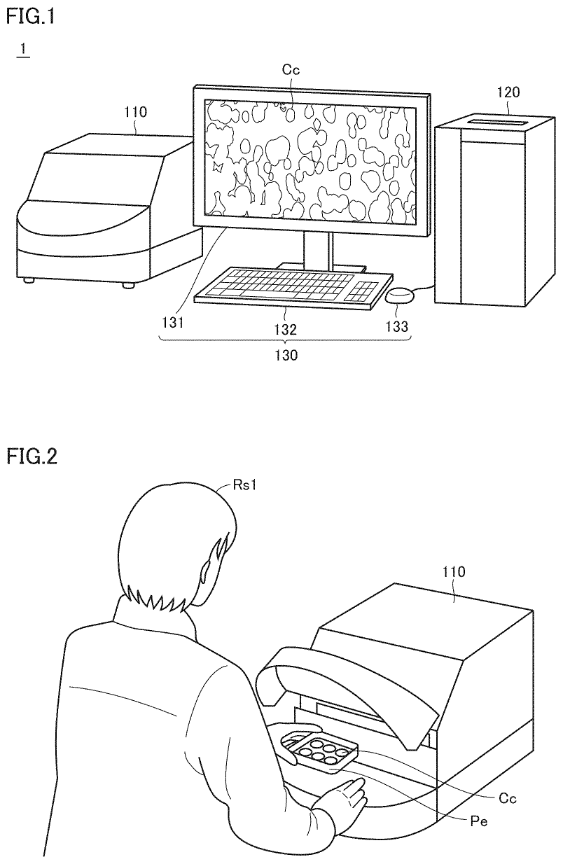

FIG. 1 is a perspective view showing an appearance of a cell analysis apparatus 1, which is one example of an image analysis apparatus according to an embodiment. As shown in FIG. 1, cell analysis apparatus 1 includes a digital holography apparatus 110, an information processing apparatus 120, and an input and output unit 130.

Digital holography apparatus 110 includes an in-line holographic microscopy (IHM). Information processing apparatus 120 includes a personal computer or a workstation. Input and output unit 130 includes a display 131, a keyboard 132 and a mouse 133. In FIG. 1, a plurality of cells Cc observed by digital holography apparatus 110 are displayed on display 131.

FIG. 2 shows a state in which a user Rs1 is arranging a cell culture plate Pe at a prescribed location of digital holography apparatus 110 in FIG. 1. As shown in FIG. 2, a plurality of cells Cc to be observed are included in cell culture plate Pe.

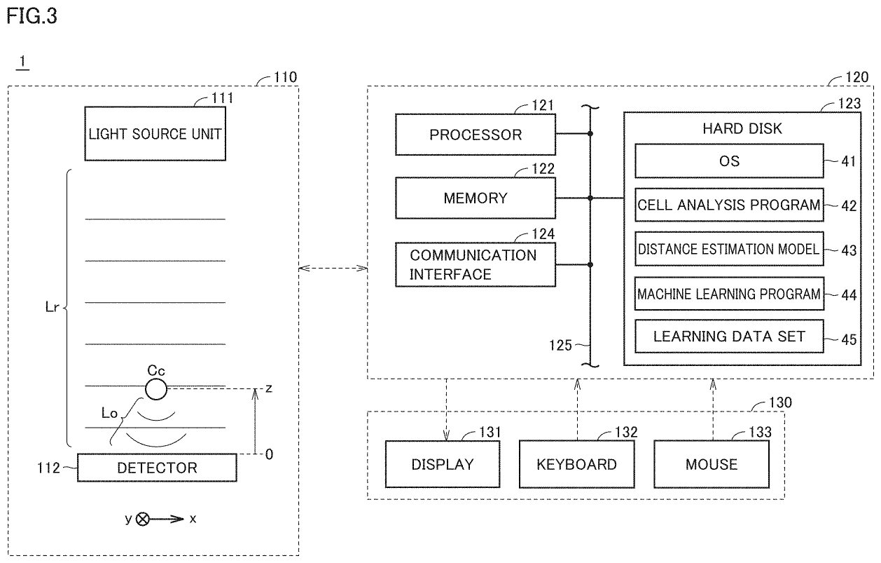

FIG. 3 is a block diagram showing a functional configuration of cell analysis apparatus 1 in FIG. 1. As shown in FIG. 3, digital holography apparatus 110 includes a light source unit 111 and a detector 112. An object to be observed is arranged between light source unit 111 and detector 112. In FIG. 3, the object is cell Cc. An x axis, a y axis and a z axis shown on digital holography apparatus 110 are orthogonal to each other.

Light source unit 111 includes a laser diode and emits coherent light to cell Cc. Detector 112 includes an image sensor. Of the coherent light from light source unit 111, detector 112 receives object light Lo diffracted at cell Cc and reaching detector 112, and reference light Lr reaching detector 112 without going through cell Cc. Detector 112 generates an interference fringe image produced as a result of interference between object light Lo and reference light Lr at a detection surface, and transmits the interference fringe image to information processing apparatus 120. A distance z between detector 112 and cell Cc corresponds to a focal distance required for image reproduction by light wave propagation calculation described below.

Information processing apparatus 120 includes a processor 121, a memory 122 and a hard disk 123 that serve as a storage unit, and a communication interface 124. These are communicatively connected to each other through a bus 125.

Hard disk 123 is a non-volatile storage device. An operating system (OS) program 41, a cell analysis application program 42, a distance estimation model 43, a machine learning program 44, and a learning data set 45 including a plurality of pieces of learning data are, for example, stored in hard disk 123. Distance estimation model 43 is a neural network model that receives a plurality of feature quantities and estimates focal distance z. Machine learning program 44 is a program for performing supervised learning using the learning data set on distance estimation model 43. In addition to the data shown in FIG. 3, settings and outputs of various applications and the interference fringe image transmitted from detector 112 are, for example, stored in hard disk 123. Memory 122 is a volatile storage device and includes, for example, a dynamic random access memory (DRAM).

Processor 121 includes a central processing unit (CPU). Processor 121 may further include a graphics processing unit (GPU). Processor 121 implements various functions of cell analysis apparatus 1 by reading the programs stored in hard disk 123 into memory 122 and executing the programs. For example, processor 121 that executes the cell analysis program functions as an analysis unit. Processor 121 that executes machine learning program 44 functions as a learning unit. Cell analysis apparatus 1 has both a learning function of generating a trained model and an inference function using the trained model. The learning function may include an additional learning function of further learning trained distance estimation model 43.

Processor 121 is connected to a network such as a local area network (LAN) through communication interface 124. Digital holography apparatus 110 is connected to the network. Digital holography apparatus 110 and information processing apparatus 120 may be directly connected by, for example, universal serial bus (USB) connection or the like. In addition, a plurality of digital holography apparatuses 110 may be connected to information processing apparatus 120.

A graphical user interface (GUI) of the cell analysis application and an output of the cell analysis application such as an image processing result of cell Cc are displayed on display 131. The user inputs a desired operation to the cell analysis application through keyboard 132 and mouse 133, while referring to the display on display 131.

In cell analysis apparatus 1, an in-focus image of an object to be observed is reproduced from an interference fringe image of the object to be observed by light wave propagation calculation using the following equation (1):

E(x, y, z)=FFT⁻¹[α(k_{w}, z)·FFT{E(x, y, 0)}] (1).

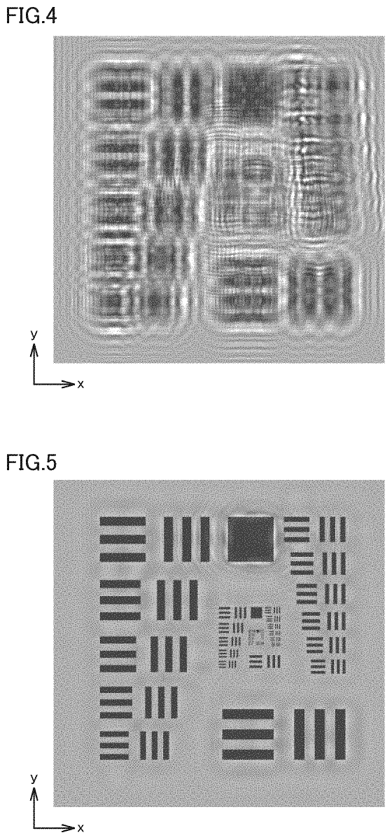

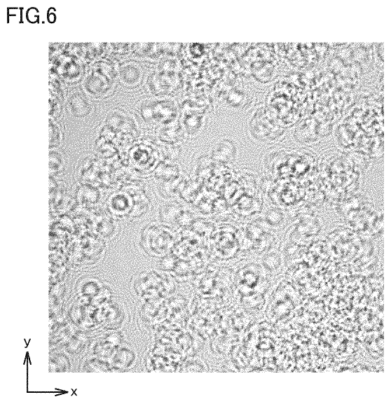

FFT and FFT⁻¹ represent Fourier transform and inverse Fourier transform, respectively. E(x,y,0) represents a complex wave surface (interference fringe image) at the detection surface of detector 112. E(x,y,z) represents a complex wave surface (reproduced image) at an object surface at a position of the object to be observed. The interference fringe image and the reproduced image are, for example, the images shown in FIGS. 4 and 5, respectively. The reproduced image shown in FIG. 5 is an image reproduced using the equation (1) from the interference fringe image shown in FIG. 4 in which focal distance z is known. An x axis and a y axis in FIGS. 4 and 5 correspond to the x axis and the y axis in FIG. 3, respectively. The same applies as well to FIG. 6 described below.

As shown in the equation (1), Fourier transform is performed on the interference fringe image, and then, each spectrum component is multiplied by a coefficient α corresponding to focal distance z and a frequency component k_{w}, and inverse Fourier transform is further performed, to thereby calculate a reproduced image. Coefficient α is expressed like the following equation (2):

α(k_{w}, z)=exp(i\sqrt{k²−k_{w}²}·z) (2).

k in the equation (2) represents the number of waves and is expressed like the following equation (3). Frequency component k_{w} in the equation (2) is expressed like the following equation (4).

k=2π/λ (3)

k_{w}=\sqrt{kₓ²+k_{y}²} (4)

λ in the equation (3) represents a wavelength of the coherent light emitted from light source unit 111. Since the number of waves k is a fixed value determined by wavelength λ, coefficient α by which frequency component k_{w} is multiplied at focal distance z is a constant value. kₓ in the equation (4) represents an angular frequency in an x direction and is expressed like the following equation (5). k_{y} in the equation (4) represents an angular frequency in a y direction and is expressed like the following equation (6).

kₓ=u·2π/(pₓ·nₓ) (5)

k_{y}=v·2π/(p_{y}·n_{y}) (6)

u in the equation (5) and v in the equation (6) represent a frequency in the x direction and a frequency in the y direction, respectively. pₓ and p_{y} represent a pixel size of the interference fringe image in the x direction and a pixel size of the interference fringe image in the y direction, respectively. nₓ and n_{y} represent the number of pixels in the interference fringe image in the x direction and the number of pixels in the interference fringe image in the y direction, respectively.

In a two-dimensional power spectrum obtained by Fourier transform of the interference fringe image, an intensity is specified by angular frequency kₓ and k_{y}. Frequency component k_{w} corresponds to a radius of a circle having, as an origin point, a point at which angular frequencies kₓ and k_{y} are both zero, in a two-dimensional power spectrum image. Since coefficient a by which the same frequency component (radius) is multiplied at focal distance z is a constant value, a pattern having the intensity that changes concentrically around the origin point is often seen in the two-dimensional power spectrum image.

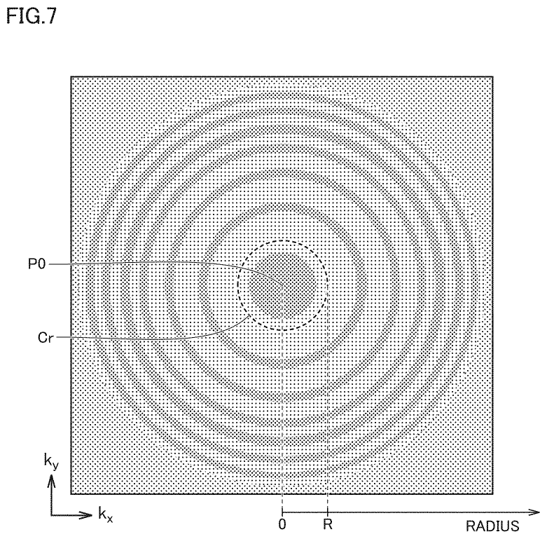

FIG. 6 shows one example of the interference fringe image of a plurality of cells Cc. FIG. 7 schematically shows the two-dimensional power spectrum image obtained by Fourier transform of the interference fringe image in FIG. 6. As shown in FIG. 7, a pattern having an intensity that changes concentrically around an origin point P0 is seen.

The pattern includes information about focal distance z. However, for example, when a ratio of a region occupied by an object to be observed is small in a region where an interference fringe image is taken, or when an unintended element (e.g., a scratch of cell culture plate Pe) is included in the region where the interference fringe image is taken, information that does not result from the object to be observed may be dominant in a two-dimensional power spectrum image. In such a case, a ratio of information related to a focal distance included in the two-dimensional power spectrum image is reduced. As a result, estimation of focal distance z may become difficult, depending on a distance estimation model (e.g., CNN) that receives the entire two-dimensional power spectrum image as an input value.

Accordingly, in cell analysis apparatus 1, a one-dimensional power spectrum is generated by, for each frequency component k_{w}, associating frequency component k_{w} with a feature quantity calculated by aggregating a plurality of intensities corresponding to frequency component k_{w}, and the one-dimensional power spectrum is used as an input value of distance estimation model 43. Information about a feature of focal distance z is extracted from the two-dimensional power spectrum into the one-dimensional power spectrum. As compared with the case of using the CNN or the like that receives the two-dimensional power spectrum image itself as the input value of the distance estimation model, a ratio of the information about focal distance z included in the input value of distance estimation model 43 is increased. As a result, the accuracy of estimation of focal distance z in digital holography can be enhanced. In addition, the size of the neural network included in distance estimation model 43 can be reduced and the cost (time and space) of machine learning for constructing a trained model composed of the neural network can be reduced.

In FIG. 7, a circle Cr centered at origin point P0 and having a radius R is indicated by a dotted line. Radius R corresponds to frequency component k_{w}. A plurality of intensities (pixel values) on circle Cr are aggregated and a feature quantity fv corresponding to radius R (frequency component k_{w}) is calculated. Feature quantity fv is calculated for each radius R and a one-dimensional power spectrum is generated by associating a plurality of radii R with a plurality of feature quantities fv, respectively.

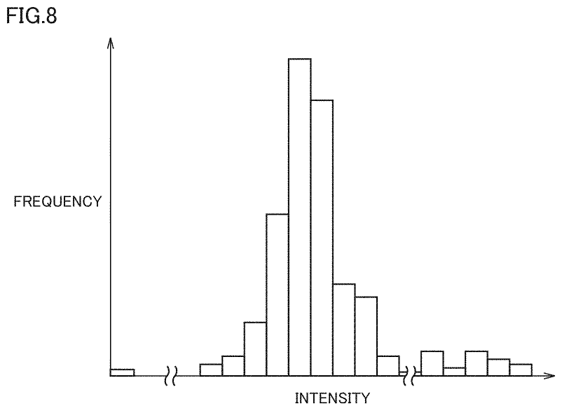

Feature quantity fv is desirably a statistic indicating the tendency of a plurality of intensities. For example, feature quantity fv is an average value of a plurality of intensities. Alternatively, feature quantity fv may be calculated based on a histogram shown in FIG. 8 generated from a plurality of intensities. Feature quantity fv based on the histogram includes, for example, an average value, a median value or a most frequent value.

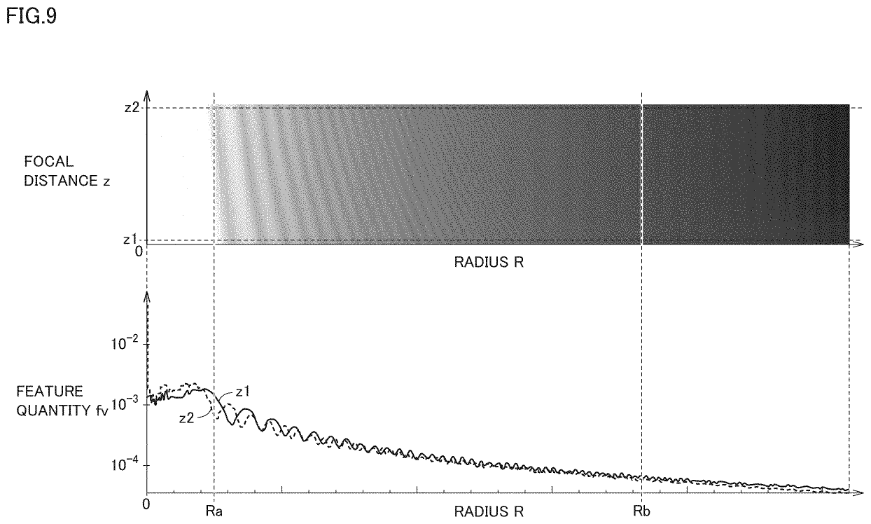

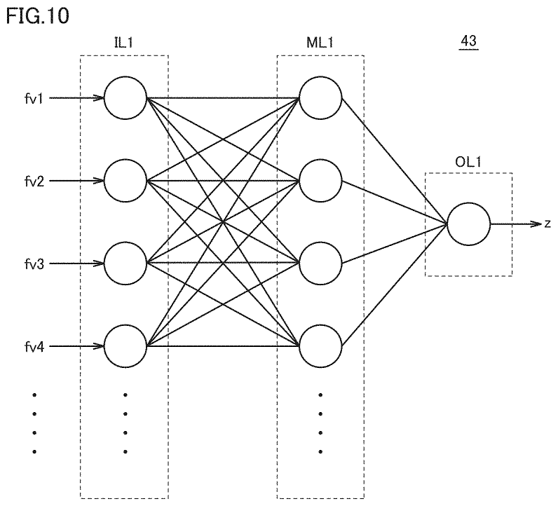

FIG. 9 shows a correspondence relationship among radius R, focal distance z and feature quantity fv in the one-dimensional power spectrum, and a correspondence relationship between radius R and feature quantity fv. In the correspondence relationship among radius R, focal distance z and feature quantity fv, the magnitude of feature quantity fv is indicated by color gradation at a position specified by radius R and focal distance z. In the correspondence relationship between radius R and feature quantity fv, a correspondence relationship when focal distance z is z1 (solid line) and a correspondence relationship when focal distance z is z2 (dotted line) are indicated. As shown in FIG. 9, a plurality of feature quantities fv included in the one-dimensional power spectrum vary depending on focal distance z. Therefore, focal distance z can be specified by the plurality of feature quantities fv.

It is unnecessary to use all of feature quantities fv included in the one-dimensional power spectrum in order to specify focal distance z. For example, a portion in which a radius corresponding to a low frequency component is not less than 0 and not more than Ra and a portion in which a radius corresponding to a high frequency component is not less than Rb may be excluded from all of feature quantities fv included in the one-dimensional power spectrum. By limiting the frequency component used to specify focal distance z to a range where a feature of focal distance z is likely to appear, the size of the neural network included in distance estimation model 43 can be further reduced and the accuracy of estimation of focal distance z can be further enhanced. Radii Ra and Rb can be determined as appropriate by an experiment conducted on an actual apparatus or simulation.

Distance estimation model 43 may be a regression model or a classification model. FIG. 10 shows a network structure when distance estimation model 43 in FIG. 3 is a regression model. As shown in FIG. 10, distance estimation model 43 includes an input layer IL1, an intermediate layer ML1 and an output layer OL1. Each of input layer IL1 and intermediate layer ML1 includes a plurality of neurons. Output layer OL1 includes one neuron. A plurality of feature quantities fv are input to the plurality of neurons included in input layer IL1, respectively. Each of the plurality of neurons included in input layer IL1 is coupled to the plurality of neurons included in intermediate layer ML1. That is, input layer IL1 and intermediate layer ML1 are fully connected to each other. Each of the plurality of neurons included in intermediate layer ML1 is coupled to the neuron included in output layer OL1. Focal distance z is output from output layer OL1.

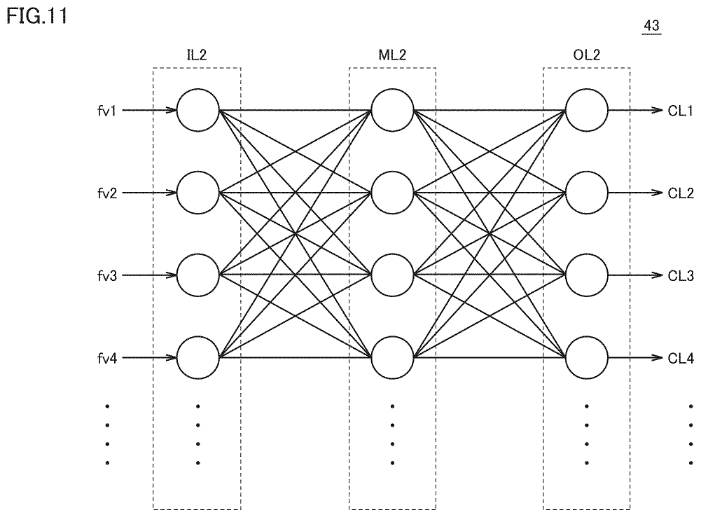

FIG. 11 shows a network structure when distance estimation model 43 in FIG. 3 is a classification model. As shown in FIG. 11, distance estimation model 43 includes an input layer IL2, an intermediate layer ML2 and an output layer OL2. Each of input layer IL2, intermediate layer ML2 and output layer OL2 includes a plurality of neurons. A plurality of feature quantities fv are input to the plurality of neurons included in input layer IL2, respectively. Each of the plurality of neurons included in input layer IL2 is coupled to the plurality of neurons included in intermediate layer ML2. That is, input layer IL2 and intermediate layer ML2 are fully connected to each other. Each of the plurality of neurons included in intermediate layer ML2 is coupled to the plurality of neurons included in output layer OL2. That is, intermediate layer ML2 and output layer OL2 are fully connected to each other. For each of a plurality of classes, a probability that a one-dimensional power spectrum having a plurality of feature quantities fv is classified into the class is output from output layer OL2. Each class is associated with focal distance z. Focal distance z for the class having the highest probability is selected.

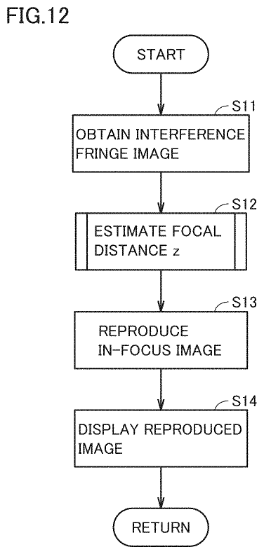

FIG. 12 is a flowchart showing an image reproduction process performed by processor 121 that functions as an analysis unit. The process shown in FIG. 7 is invoked by a not-shown main routine that comprehensively controls the cell analysis application. In the following description, a step will be simply denoted as “S”.

As shown in FIG. 12, in S11, processor 121 obtains an interference fringe image of an object to be observed, which is generated by detector 112, and moves the process to S12. In S12, processor 121 estimates focal distance z using distance estimation model 43, and moves the process to S13. In S13, processor 121 reproduces an in-focus image of the object to be observed using focal distance z estimated in S12 and the equation (1), and moves the process to S14. In S14, processor 121 displays the reproduced image on display 131, and returns the process to the main routine.

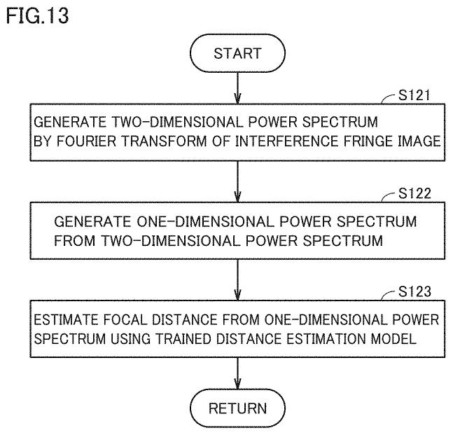

FIG. 13 is a flowchart showing a specific process flow of the process in S12 in FIG. 12. As shown in FIG. 13, in S121, processor 121 generates a two-dimensional power spectrum by Fourier transform of the interference fringe image, and moves the process to S122. In S122, processor 121 generates a one-dimensional power spectrum from the two-dimensional power spectrum, and moves the process to S123. In S123, processor 121 estimates a focal distance from the one-dimensional power spectrum using trained distance estimation model 43, and returns the process to the main routine.

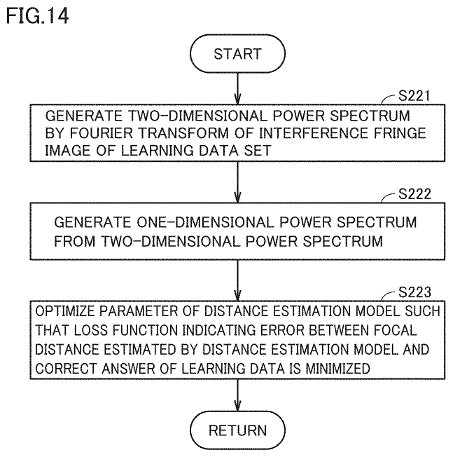

FIG. 14 is a flowchart showing a flow of a machine learning process performed by processor 121 that functions as a learning unit. The process shown in FIG. 14 is invoked by a not-shown main routine that comprehensively controls the machine learning process.

As shown in FIG. 14, in S221, processor 121 generates a two-dimensional power spectrum by Fourier transform of an interference fringe image of learning data included in a learning data set, and moves the process to S222. The learning data includes an actually measured focal distance as a correct answer in supervised learning. In S222, processor 121 generates a one-dimensional power spectrum from the two-dimensional power spectrum, and moves the process to S223. In S223, processor 121 optimizes a parameter of distance estimation model 43 by back propagation such that a loss function indicating an error between focal distance z estimated from the one-dimensional power spectrum by the distance estimation model and the correct answer of the learning data is minimized, and returns the process to the main routine.

The parameter optimized in S223 includes a weight and a bias of the neural network. The loss function when distance estimation model 43 is a regression model is, for example, a mean square error. The loss function when distance estimation model 43 is a classification model is, for example, a softmax entropy. A method for machine learning for distance estimation model 43 may be batch learning, mini-batch learning, or on-line learning.

In the embodiment, description has been given of the case in which the image analysis apparatus has the learning function and the trained model of the distance estimation model can be constructed. However, the image analysis apparatus does not necessarily need to have the learning function and a trained distance estimation model constructed by another learning apparatus may be prestored in the image analysis apparatus.

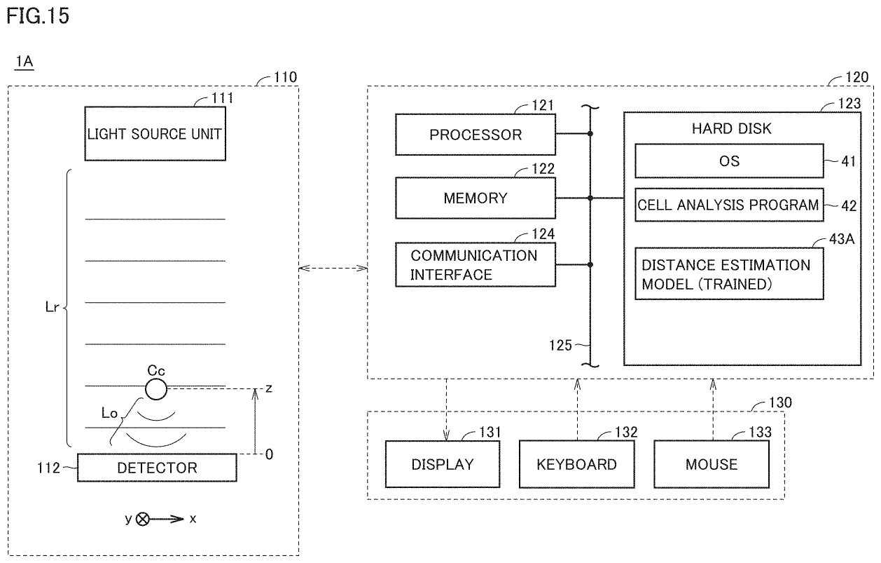

FIG. 15 is a block diagram showing a functional configuration of a cell analysis apparatus 1A, which is one example of an image analysis apparatus according to a modification of the embodiment. A configuration of cell analysis apparatus 1A is implemented by removing machine learning program 44 and learning data set 45 from hard disk 123 in FIG. 3 and replacing distance estimation model 43 with a distance estimation model 43A. Distance estimation model 43A is a trained model constructed by a learning apparatus different from cell analysis apparatus 1A.

The object to be observed in the image reproduction method and the image analysis apparatus according to the embodiment and the modification is not limited to the cell. The object to be observed may be any object as long as it has transparency.

As described above, in the image reproduction method and the image analysis apparatus according to the embodiment and the modification, the accuracy of estimation of the focal distance in digital holography can be enhanced.

[Aspects]

It is understood by those skilled in the art that the above-described exemplary embodiment is a specific example of the following aspects.

(Clause 1)

An image reproduction method according to an aspect reproduces an in-focus image of an object from an interference fringe image, the interference fringe image being generated from object light and reference light, of light emitted from a light source unit to the object, the object light being diffracted at the object and reaching a detector, the reference light reaching the detector without going through the object. The image reproduction method includes: generating a two-dimensional power spectrum; generating a one-dimensional power spectrum; and estimating. In the generating a two-dimensional power spectrum, the two-dimensional power spectrum is generated from the interference fringe image, the two-dimensional power spectrum having an intensity specified by a first frequency in a first direction in the interference fringe image and a second frequency in a second direction in the interference fringe image. In the generating a one-dimensional power spectrum, for each frequency component specified by the first frequency and the second frequency in the two-dimensional power spectrum, the frequency component is associated with a feature quantity, the feature quantity being calculated by aggregating a plurality of intensities corresponding to the frequency component. In the estimating, a focal distance between the object and the detector is estimated using a trained distance estimation model, the trained distance estimation model receiving, as input, a plurality of feature quantities included in the one-dimensional power spectrum.

According to the image reproduction method as recited in clause 1, the plurality of feature quantities included in the one-dimensional power spectrum having the information about the focal distance extracted from the two-dimensional power spectrum are used, and thus, the accuracy of estimation of the focal distance in digital holography can be enhanced.

(Clause 2)

In the image reproduction method according to clause 1, the feature quantity includes a statistic of the plurality of intensities.

According to the image reproduction method as recited in clause 2, the tendency of the plurality of intensities is reflected in the feature quantity, and thus, the information about the focal distance included in the two-dimensional power spectrum is integrated into the one-dimensional power spectrum. As a result, the accuracy of estimation of the focal distance can be further enhanced.

(Clause 3)

In the image reproduction method according to clause 2, the statistic includes an average value of the plurality of intensities.

According to the image reproduction method as recited in clause 3, the average value of the plurality of intensities is used as the feature quantity, and thus, the information about the focal distance included in the two-dimensional power spectrum is integrated into the one-dimensional power spectrum in a well-balanced manner. As a result, the accuracy of estimation of the focal distance can be further enhanced.

(Clause 4)

In the image reproduction method according to clause 2, the statistic includes a value based on a histogram obtained by aggregating the plurality of intensities.

According to the image reproduction method as recited in clause 4, the value based on the histogram obtained by aggregating the plurality of intensities is used as the feature quantity, and thus, the information about the focal distance included in the two-dimensional power spectrum can be integrated into the one-dimensional power spectrum from various viewpoints. As a result, the accuracy of estimation of the focal distance can be further enhanced.

(Clause 5)

In the image reproduction method according to any one of clauses 1 to 4, a part of all of the feature quantities included in the one-dimensional power spectrum are input to the distance estimation model.

According to the image reproduction method as recited in clause 5, the size of the distance estimation model can be reduced and the cost of machine learning for constructing the trained model of the distance estimation model can be reduced.

(Clause 6)

In the image reproduction method according to any one of clauses 1 to 5, the object includes a cell.

According to the image reproduction method as recited in clause 6, the user does not need to adjust the focal distance with respect to each of a large amount of images of cells taken while changing a plane position of the cell culture plate, and the images having the automatically adjusted focal distances can be reproduced.

(Clause 7)

An image analysis apparatus according to an aspect reproduces an in-focus image of an object from an interference fringe image, the interference fringe image being generated from object light and reference light, of light emitted from a light source unit to the object, the object light being diffracted at the object and reaching a detector, the reference light reaching the detector without going through the object. The image analysis apparatus includes: a storage unit; a learning unit; and an inference unit. The storage unit stores a distance estimation model. The learning unit constructs a trained model of the distance estimation model by supervised learning. The inference unit estimates a focal distance between the object and the detector using the distance estimation model. The inference unit generates a two-dimensional power spectrum from the interference fringe image, the two-dimensional power spectrum having an intensity specified by a first frequency in a first direction in the interference fringe image and a second frequency in a second direction in the interference fringe image. The inference unit generates a one-dimensional power spectrum by, for each frequency component specified by the first frequency and the second frequency in the two-dimensional power spectrum, associating the frequency component with a feature quantity, the feature quantity being calculated by aggregating a plurality of intensities corresponding to the frequency component. The inference unit estimates the focal distance by inputting a plurality of feature quantities included in the one-dimensional power spectrum to the distance estimation model.

According to the image analysis apparatus as recited in clause 7, the plurality of feature quantities included in the one-dimensional power spectrum having the information about the focal distance extracted from the two-dimensional power spectrum are used, and thus, the accuracy of estimation of the focal distance in digital holography can be enhanced.

(Clause 8)

An image analysis apparatus according to another aspect reproduces an in-focus image of an object from an interference fringe image, the interference fringe image being generated from object light and reference light, of light emitted from a light source unit to the object, the object light being diffracted at the object and reaching a detector, the reference light reaching the detector without going through the object. The image analysis apparatus includes: a storage unit; and an inference unit. The storage unit stores a trained distance estimation model. The inference unit estimates a focal distance between the object and the detector using the distance estimation model. The inference unit generates a two-dimensional power spectrum from the interference fringe image, the two-dimensional power spectrum having an intensity specified by a first frequency in a first direction in the interference fringe image and a second frequency in a second direction in the interference fringe image. The inference unit generates a one-dimensional power spectrum by, for each frequency component specified by the first frequency and the second frequency in the two-dimensional power spectrum, associating the frequency component with a feature quantity, the feature quantity being calculated by aggregating a plurality of intensities corresponding to the frequency component. The inference unit estimates the focal distance by inputting a plurality of feature quantities included in the one-dimensional power spectrum to the distance estimation model.

According to the image analysis apparatus as recited in clause 8, the plurality of feature quantities included in the one-dimensional power spectrum having the information about the focal distance extracted from the two-dimensional power spectrum are used, and thus, the accuracy of estimation of the focal distance in digital holography can be enhanced.

As to the above-described embodiment and modification, it is originally intended that the features described in the embodiment, including any combination not mentioned in the specification, may be combined as appropriate within a range that does not cause inconvenience or contradiction.

While the embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. An image reproduction method for reproducing an in-focus image of an object from an interference fringe image, the interference fringe image being generated from object light and reference light, of light emitted from a light source unit to the object, the object light being diffracted at the object and reaching a detector, the reference light reaching the detector without going through the object, the image reproduction method comprising:
generating a two-dimensional power spectrum from the interference fringe image, the two-dimensional power spectrum having an intensity specified by a first frequency in a first direction in the interference fringe image and a second frequency in a second direction in the interference fringe image;
generating a one-dimensional power spectrum by, for each frequency component specified by the first frequency and the second frequency in the two-dimensional power spectrum, associating the frequency component with a feature quantity, the feature quantity being calculated by aggregating a plurality of intensities corresponding to the frequency component; and
estimating a focal distance between the object and the detector using a trained distance estimation model, the trained distance estimation model receiving, as input, a plurality of feature quantities included in the one-dimensional power spectrum.

2. The image reproduction method according to claim 1, wherein
the feature quantity includes a statistic of the plurality of intensities.

3. The image reproduction method according to claim 2, wherein
the statistic includes an average value of the plurality of intensities.

4. The image reproduction method according to claim 2, wherein
the statistic includes a value based on a histogram obtained by aggregating the plurality of intensities.

5. The image reproduction method according to claim 1, wherein
a part of all of the feature quantities included in the one-dimensional power spectrum are input to the distance estimation model.

6. The image reproduction method according to claim 1, wherein
the object includes a cell.

7. An image analysis apparatus that reproduces an in-focus image of an object from an interference fringe image, the interference fringe image being generated from object light and reference light, of light emitted from a light source unit to the object, the object light being diffracted at the object and reaching a detector, the reference light reaching the detector without going through the object, the image analysis apparatus comprising:
a storage unit that stores a distance estimation model;
a learning unit that constructs a trained model of the distance estimation model by supervised learning; and
an inference unit that estimates a focal distance between the object and the detector using the distance estimation model, wherein
the inference unit
generates a two-dimensional power spectrum from the interference fringe image, the two-dimensional power spectrum having an intensity specified by a first frequency in a first direction in the interference fringe image and a second frequency in a second direction in the interference fringe image,
generates a one-dimensional power spectrum by, for each frequency component specified by the first frequency and the second frequency in the two-dimensional power spectrum, associating the frequency component with a feature quantity, the feature quantity being calculated by aggregating a plurality of intensities corresponding to the frequency component, and
estimates the focal distance by inputting a plurality of feature quantities included in the one-dimensional power spectrum to the distance estimation model.

8. An image analysis apparatus that reproduces an in-focus image of an object from an interference fringe image, the interference fringe image being generated from object light and reference light, of light emitted from a light source unit to the object, the object light being diffracted at the object and reaching a detector, the reference light reaching the detector without going through the object, the image analysis apparatus comprising:
a storage unit that stores a trained distance estimation model; and
an inference unit that estimates a focal distance between the object and the detector using the distance estimation model, wherein
the inference unit
generates a two-dimensional power spectrum from the interference fringe image, the two-dimensional power spectrum having an intensity specified by a first frequency in a first direction in the interference fringe image and a second frequency in a second direction in the interference fringe image;
generates a one-dimensional power spectrum by, for each frequency component specified by the first frequency and the second frequency in the two-dimensional power spectrum, associating the frequency component with a feature quantity, the feature quantity being calculated by aggregating a plurality of intensities corresponding to the frequency component; and
estimates the focal distance by inputting a plurality of feature quantities included in the one-dimensional power spectrum to the distance estimation model.
